(19) United States
(12) Patent Application Publication
(10) Pub. No.: US 2004/0257184 A1
(43) Pub. Date: Dec. 23, 2004

(54) Six-pole to three-pole bussing for a network protector

(76) Inventors: Steven E. Meiners, Greenwood, SC (US); Arthur J. Jur, Greenwood, SC (US); Stephen W. Oneufer, Cranberry Township, PA (US); Michael F. Magazine, Carnegie, PA (US); Douglas M. Brandt, Greenwood, SC (US)

Correspondence Address: Martin J. Moran, Esquire, Cutler Hammer, Technology & Quality Center, RIDC Park West, 170 Industry Drive, Pittsburgh, PA, 15275-1032, US

(21) Appl. No.: 10/464,699

(22) Filed: Jun. 18, 2003

(51) Int. Cl. H01H 9/02

(52) U.S. Cl. 335/202

(57) ABSTRACT

A network protector bus assembly, which is structured to be coupled to a roll-out circuit breaker having a plurality of quick disconnect assemblies, includes a line buss assembly and a load bus assembly. The line bus assembly has three elongated bus sub-assemblies, each with a stab extending generally perpendicular to the longitudinal axis of the line bus sub-assemblies. Each line bus sub-assembly stab has a width sufficient to accommodate at least two circuit breaker quick disconnect assemblies. Similarly, the load bus assembly has three elongated bus sub-assemblies, each with a stab extending generally perpendicular to the longitudinal axis of the load bus sub-assemblies. Again, each load bus sub-assembly stab has a width sufficient to accommodate at least two circuit breaker quick disconnect assemblies.

### BACKGROUND OF THE INVENTION

1. Field of the Invention

This invention relates to a network protector and, more specifically, to a network protector which incorporates a six-pole circuit breaker and a three-pole bus.

2. Background Information

Secondary power distribution networks consist of interlaced grids which are supplied by two or more sources of power so that the loss of a single source of power will not result in an interruption of service. Such networks provide the highest level of reliability possible with conventional power distribution and are normally used to supply high-density load areas such as a section of a city, a large building, or an industrial site. Between the power sources and the network are a transformer and a network protector. The network protector consists of a circuit breaker and a control relay. The circuit breaker includes at least one set of main contacts that move between an open position and a closed position. When the main contacts are closed, electricity may flow through the network protector. The control relay senses the transformer and network voltages and line currents and executes algorithms to initiate breaker tripping or closing action. Trip determination is based on detecting an overcurrent condition or reverse power flow, that is, power flow from the network to the energy source.

Network protectors are enclosed in a protective metal housing or enclosure. The enclosure is commonly enclosed in a concrete vault. The vaults are often disposed in subterranean passageways in large metropolitan areas. Given their urban, subterranean location, the size of a typical vault is limited and increasing the size of the vault to accommodate network protectors with a higher current rating is costly and difficult. As such, it is desirable to use smaller network protector components within the vault. These components, however, must be compatible with the vault busses.

The network protector buses that couple the circuit breaker to both the line and the load are mounted within the vault and coupled to external busses, i.e. a network bus or transformer bus. Typically, the network protector line and load busses are three phase busses having three poles. The poles are structured to engage quick-disconnects on the network protector circuit breaker. Typically, the circuit breaker is a roll out or drawout circuit breaker that is structured to slide horizontally within the vault as needed for replacement and maintenance. As such, the network protector line and load busses end in horizontal terminals called stabs.

Presently, the circuit breaker of a typical network protector is a three-pole circuit breaker that is structured to carry a 4500 ampere current, or less. Such three-pole circuit breakers generally have a lower interruption and fault close ratings than similarly sized six-pole circuit breakers. The six-pole circuit breakers that may carry a current of 4500 amperes, or more, will fit within a typical vault. Such six-pole circuit breakers have a higher interruption and fault close ratings. The six-pole circuit breakers, however, are not structured to be coupled to the existing three-pole line and load busses in a vault.

There is, therefore, a need for a network protector bus assembly that may be coupled to a six-pole circuit breaker within a vault as well as the three pole network bus and transformer bus.

There is a further need for a network protector bus assembly that may be coupled to a six-pole circuit breaker within presently existing vaults.

There is a further need for a network protector bus assembly that may be coupled to a rollout or drawout six-pole circuit breaker.

### SUMMARY OF THE INVENTION

These needs, and others, are met by the present invention which provides a network protector bus assembly with three sets of line and load bus sub-assemblies which are structured to be coupled to a six-pole draw-out circuit breaker having a plurality of quick disconnect assemblies. The line bus assembly has three elongated bus sub-assemblies, each with a stab extending generally perpendicular to the longitudinal axis of the line bus sub-assemblies. Each line bus sub-assembly stab has a width sufficient to accommodate at least two of the circuit breaker quick disconnect assemblies. Similarly, the load bus assembly has three elongated bus sub-assemblies, each with a stab extending generally perpendicular to the longitudinal axis of the load bus sub-assemblies. Again, each load bus sub-assembly stab has a width sufficient to accommodate at least two of the circuit breaker quick disconnect assemblies. Thus, the six-poles of the circuit breaker are coupled to the three poles of the bus assembly. The stabs of the line and load bus sub-assemblies are further spaced to engage a three-pole circuit breaker in the event such a circuit breaker is used in the enclosure.

### BRIEF DESCRIPTION OF THE DRAWINGS

A full understanding of the invention can be gained from the following description of the preferred embodiments when read in conjunction with the accompanying drawings in which:

FIG. 1 is a front view of a network protector according to the present invention.

FIG. 2 is a side view of a network protector according to the present invention.

FIG. 3A is a top schematic view of the circuit breaker bus. FIG. 3B is a side schematic view of the circuit breaker bus. FIG. 3C is a front schematic view of the circuit breaker bus.

FIG. 4 is a front view of a network protector bus assembly according to the present invention.

FIG. 5 is a side view of a network protector bus assembly according to the present invention.

FIG. 6 is an isometric view of a network protector bus assembly according to the present invention.

FIG. 7 is a schematic view of a six-pole circuit breaker engaging a three-pole network protector bus assembly according to the present invention.

### DESCRIPTION OF THE PREFERRED EMBODIMENTS

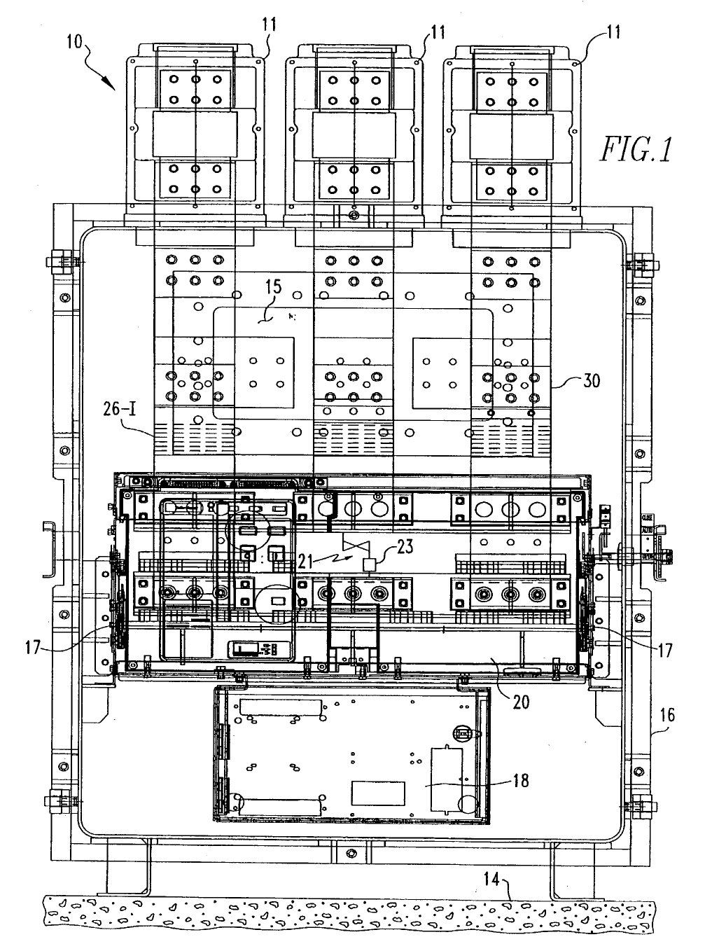

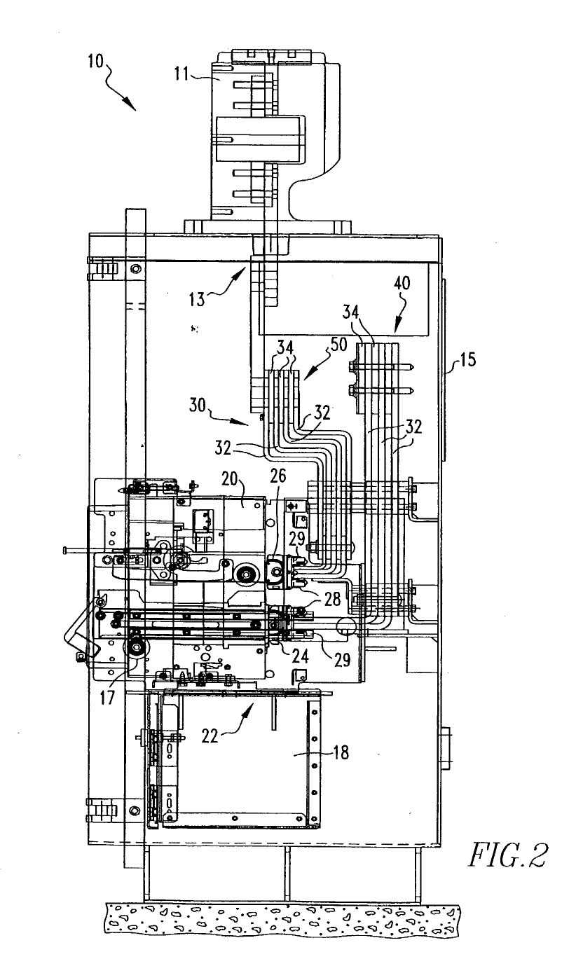

As shown in FIG. 1, a network protector 10 includes an enclosure 12, a relay 18, a six-pole circuit breaker 20 and a network protector bus assembly 30. The enclosure includes a vault 14 made from concrete or similar materials and a metal housing 16. The two primary network protector components, the relay 18 and the circuit breaker 20 are disposed within the enclosure 12. The enclosure 12 includes a set of rails 17 upon which the six-pole circuit breaker 20 may be moved into and out of the enclosure 12. The enclosure 12 includes openings 13, 15 (FIG. 2) through which a network bus fuse assembly 11 and a transformer bus (not shown) may pass. The network bus fuse assembly 11 and a transformer bus are coupled to and in electrical communication with the network protector bus assembly 30 (described below).

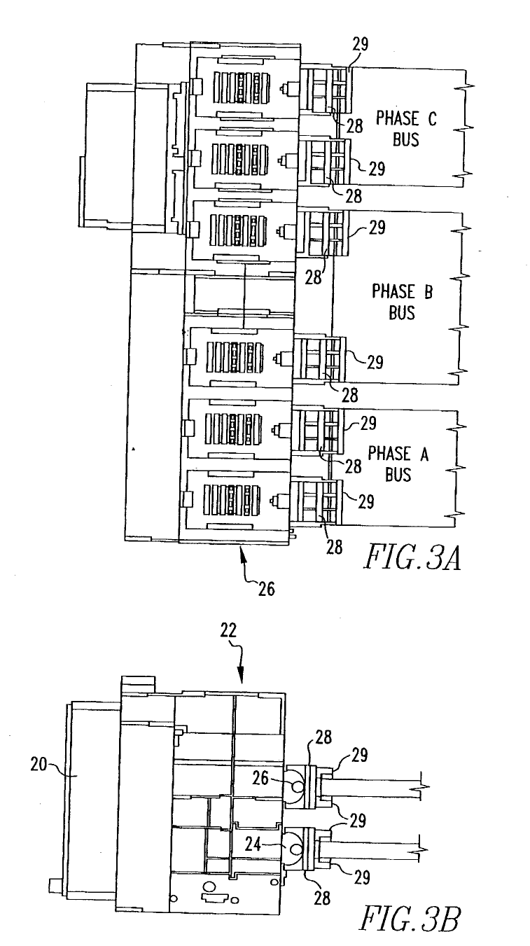

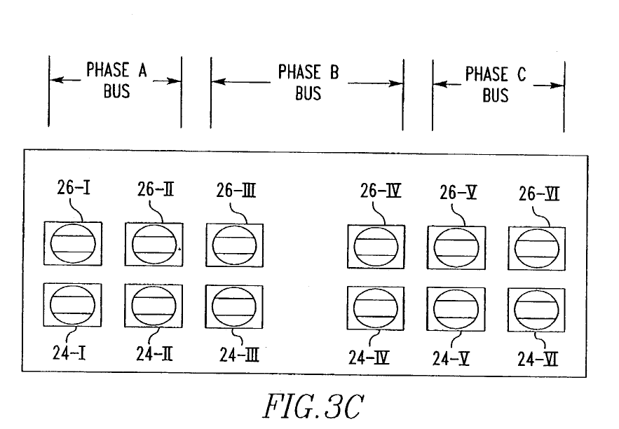

The circuit breaker 20 includes at least one set of main contacts 21 (shown schematically) that are structured to move between a first, open position and a second closed position. When the main contacts 21 are in the second, closed, electricity may flow through the six-pole circuit breaker 20. When the main contacts 21 are in the first, open position, electricity cannot flow through the circuit breaker 20. The six-pole circuit breaker 20 also includes an operating mechanism 23 (shown schematically) that is structured to move the main contacts 21 between the first and second position. As shown in FIGS. 3A-3C, within the six-pole circuit breaker 20 are a plurality of conductors 22 coupled to the main contacts. More specifically, for each pole of the six-pole circuit breaker 20 there is a line conductor 24 and a load conductor 26. These poles shall be identified associated conductors 24, 26 and quick disconnects 28 (described below) shall be identified separately as required with a Roman numeral, i.e. the conductor 24 associated with the first pole of the circuit breaker is 24-I and the conductor associated with the sixth pole of the circuit breaker is are 24-VI. Extending from one side of the circuit breaker 20 is a plurality of quick disconnects 28. Each quick disconnect 28 is coupled to each internal line conductor 24-I, 24-II, 24-III, 24-IV, 24-V, 24-VI and each load conductor 26-I, 26-II, 26-III, 26-IV, 26-V, 26-VI. As is known in the art, each quick disconnect 28 includes a plurality of fingers 29 structured to move, in a pinching motion, between an open position and a closed position thereby engaging a stab 43, 45, 47, 53, 55, 57 (described below) located on the network protector bus assembly 30 (described below). The six-pole circuit breaker 20 is a roll-out, or draw-out, type circuit breaker structured to be moved in and out of the enclosure 12.

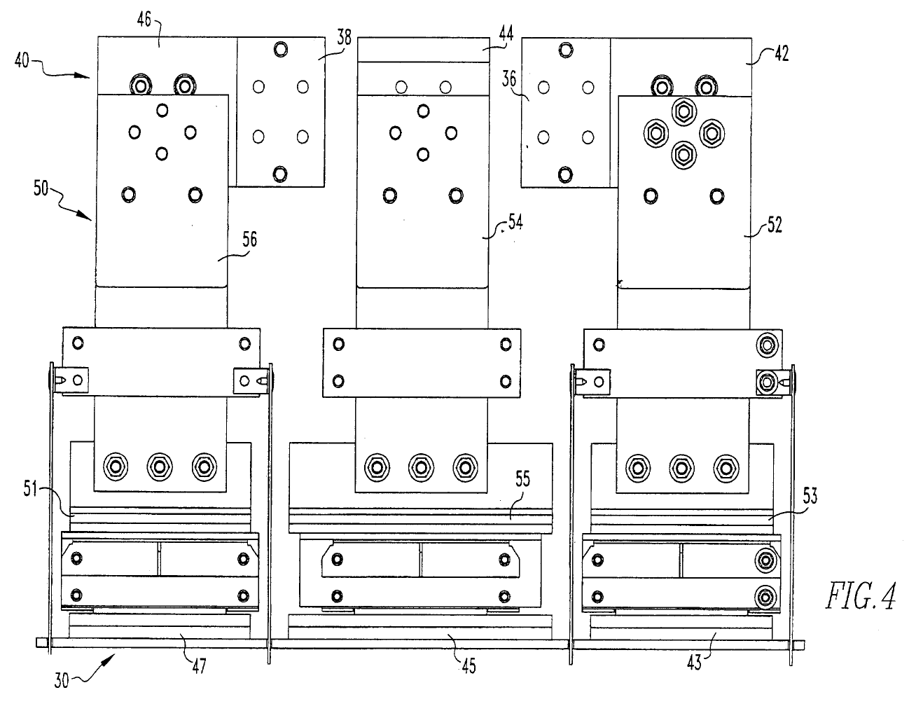

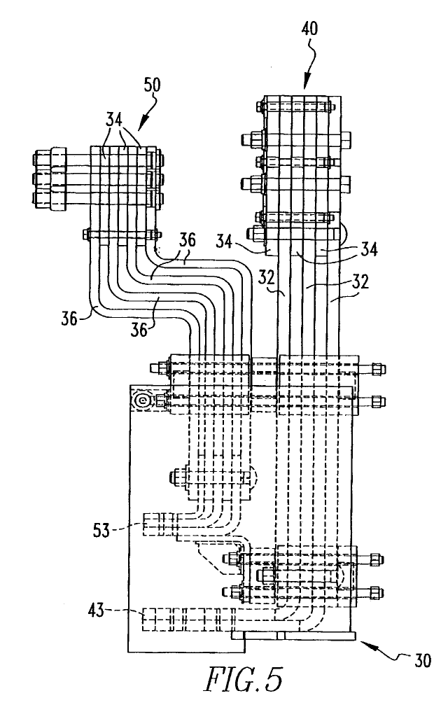

As shown in FIG. 2, the network protector bus assembly 30, which is coupled to the enclosure 12, includes a line bus assembly 40 and a load bus assembly 50. As shown in FIGS. 4-6, the network protector bus assembly 30 includes three-poles and the line bus assembly 40 and the load bus assembly 50 each have three bus sub-assemblies, that is three line bus sub-assemblies 42, 44, 46 and three load bus sub-assemblies 52, 54, 56. The current passing through the network protector bus assembly 30 is a three phase current with one phase passing through each pair of line bus sub-assemblies 42, 44, 46 and load bus sub-assemblies 52, 54, 56. As used herein, each current phase shall be represented by one of the letters A, B, or C. Thus, current phase A passes through line bus sub-assemblies 42 and load bus sub-assemblies 52, current phase B passes through line bus sub-assemblies 44 and load bus sub-assemblies 54, and current phase C passes through line bus sub-assemblies 46 and load bus sub-assemblies 56.

Each line bus sub-assembly 42, 44, 46 and load bus sub-assembly 52, 54, 56 includes a plurality of elongated bus members 32. The bus members 32 are made from a conductive material. The bus members 32 are held in a spaced relation by non-conductive spacers 34. Thus, each line bus sub-assembly 42, 44, 46 and load bus sub-assembly 52, 54, 56 is a laminated assembly. A stab 43, 45, 47, 53, 55, 57 is located at one end of each line bus sub-assembly 42, 44, 46 and load bus sub-assembly 52, 54, 56. Each stab 43, 45, 47, 53, 55, 57 is a portion of the elongated bus members 32 that extends generally perpendicular to the longitudinal axis of the elongated bus members 32. Typically, as shown in FIGS. 1-2, when the network protector bus assembly 30 is mounted in the enclosure 12, the longitudinal axis of the elongated bus members 32 extends vertically and the plane of the stabs 43, 45, 47, 53, 55, 57 extends horizontally. Additionally, the two outer line bus sub-assemblies 42, 46, corresponding to phase A and phase C, may include an offset bus 36, 38. The offset bus extends towards the middle line bus sub-assembly 44 and allows the two outer line bus sub-assemblies 42, 46 to be coupled to a transformer bus extending into the tank 16 through opening 15.

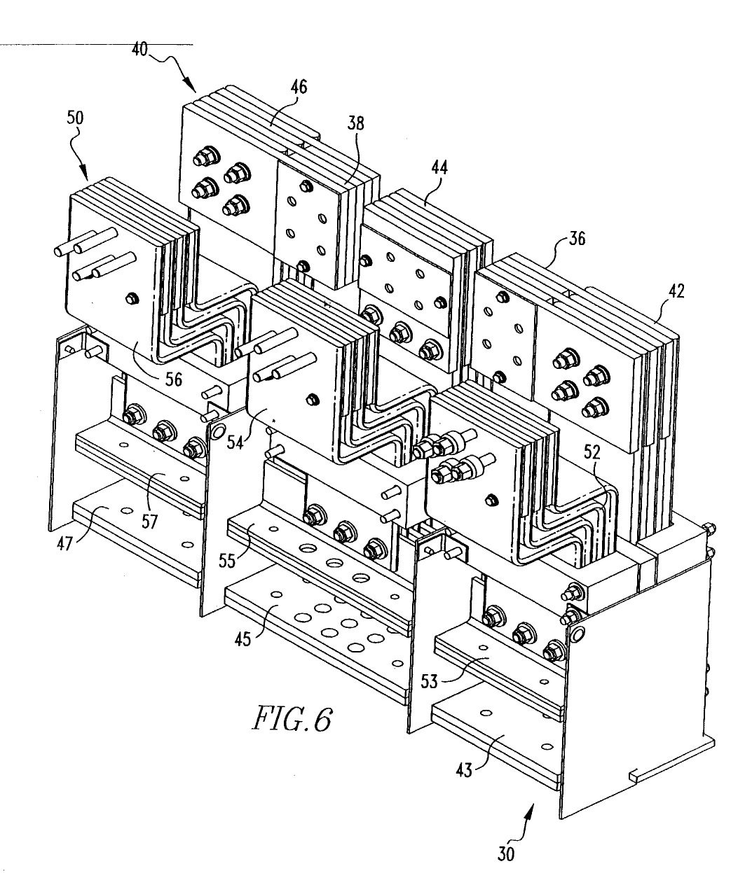

Each stab is structured to be engaged by a pair of quick disconnects 28 coupled to either an internal line conductor 24-I, 24-II, 24-III, 24-IV, 24-V, 24-VI or a load conductor 26-I, 26-II, 26-III, 26-IV, 26-V, 26-VI. Thus each stab 43, 45, 47, 53, 55, 57 has a width sufficient to accommodate two quick disconnects 28. Preferably, the width of the stabs 43, 45, 47, 53, 55, 57 is between about 2 in. and 4 in., and more preferably about 3 in. However, the stabs 43, 45, 47, 53, 55, 57 may not have a uniform width. Certain six-pole circuit breakers 20 may not have an equal spacing between each line conductor 24 and load conductor 26. That is, as shown in FIG. 6, the line conductors 24 and load conductors 26 may be grouped in two sets of three with a slightly greater distance between the two innermost pairs of conductors 24, 26. Accordingly, the central stabs 45, 55 may have a greater width than the outer stabs 43, 47, 53, 57 to accommodate the greater spacing of the quick disconnects 28 coupled to inner pair of internal line conductors 24-III, 24-IV and the inner pair of internal load conductors 26-III, 26-IV. In this configuration, the central stabs 45, 55 have a width between about 10 in. and 14 in., and more preferably about 12 in., and the outer stabs 43, 47, 53, 57 have a width between about 7 in. and 9 in., and more preferably 8.25 in.

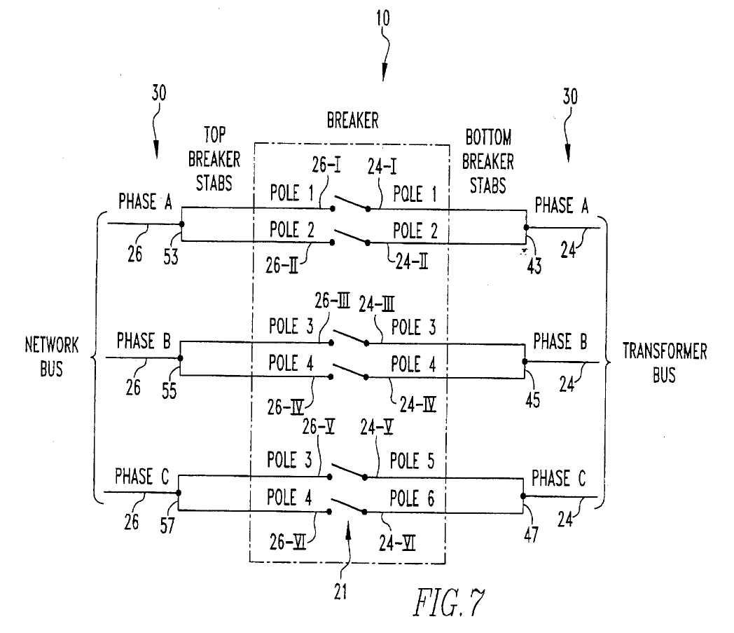

As shown schematically in FIG. 7, when the six-pole circuit breaker 20 is coupled to the three-pole network protector bus assembly 30, line conductors 24-I, 24-II are coupled to stab 43 which carries phase A of the current, line conductors 24-III, 24-IV are coupled to stab 45 which carries phase B of the current, and line conductors 24-V, 24-VI are coupled to stab 47 which carries phase C of the current. Similarly, load conductors 26-I, 26-II are coupled to stab 53 which carries phase A of the current, load conductors 26-III, 26-IV are coupled to stab 55 which carries phase B of the current, and load conductors 26-V, 26-VI are coupled to stab 57 which carries phase C of the current. Accordingly, the invention allows a six-pole circuit breaker 20 to be coupled to a three-pole network protector bus assembly 30.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. A network protector bus assembly structured to be coupled to a roll-out circuit breaker having a plurality of quick disconnect assemblies, said network protector bus assembly comprising:
a line bus assembly having three elongated bus sub-assemblies;
said line bus sub-assemblies each having a stab extending generally perpendicular to the longitudinal axis of said line bus sub-assemblies;
each said line bus sub-assembly stab having a width sufficient to accommodate at least two circuit breaker quick disconnect assemblies;
a load bus assembly having three elongated bus sub-assemblies;
said load bus subassemblies each having a stab extending generally perpendicular to the longitudinal axis of said load bus sub-assemblies; and
each said load bus sub-assembly stab having a width sufficient to accommodate at least two circuit breaker quick disconnect assemblies.

2. The network protector bus assembly of claim 1 wherein:
each said line bus sub-assembly stab has a width between about 2 in. and 4 in.; and
each said load bus sub-assembly stab has a width between about 2 in. and 4 in.

3. The network protector bus assembly of claim 2 wherein:
each said line bus sub-assembly stab has a width of about 3 in.; and
each said load bus sub-assembly stab has a width of about 3 in.

4. The network protector bus assembly of claim 2 wherein each said line bus subassembly and load bus sub-assembly includes a plurality of bus conductive members maintained in a spaced relation.

5. The network protector bus assembly of claim 2 wherein said line bus assembly includes two offset buses, each said offset bus coupled to, and in electrical communication with, a separate line bus sub-assembly and extending in a direction generally perpendicular to the longitudinal axis of said line bus sub-assemblies and the axis of said line bus sub-assembly stabs.

6. The network protector bus assembly of claim 1 wherein:
said line bus sub-assembly includes a phase A line bus sub-assembly, a phase B line bus sub-assembly, phase C line bus sub-assembly;
said load bus sub-assembly includes a phase A line bus sub-assembly, a phase B line bus sub-assembly, phase C line bus sub-assembly;
each said line phase A line bus subassembly stab, phase C line bus sub-assembly stab phase A load bus sub-assembly stab and phase C load bus subassembly stab having a width between about-7 in. and 9 in.; and
each said line phase B line bus sub-assembly stab and phase B load bus sub-assembly stab having a width between about 10 in and 14 in.

7. The network protector bus assembly of claim 6 wherein:
each said line phase A line bus sub-assembly stab, phase C line bus sub-assembly stab phase A load bus sub-assembly stab, and phase C load bus subassembly stab having a width of about 8.25 in.; and
each said line phase B line bus sub-assembly stab and phase B load bus sub-assembly stab having a width of about 12 in.

8. The network protector bus assembly of claim 6 wherein each said line bus sub-assembly and load bus sub-assembly includes a plurality of bus conductive members maintained in a spaced relation.

9. The network protector bus assembly of claim 6 wherein said line bus assembly includes two offset buses, one said offset bus coupled to, and in electrical communication with, either said phase A line bus sub-assembly or phase C line bus sub-assembly and extending in a direction generally perpendicular to the longitudinal axis of said line bus subassemblies and the axis of said line bus sub-assembly stabs,

10. A network protector assembly comprising:
an enclosure having tank openings for external network buses and transformer buses;
a relay disposed within said enclosure;
a six-pole circuit breaker having a separate internal line conductor and a separate internal load conductor for each pole and a quick disconnect coupled to each separate line and load conductor;
a three-pole network protector bus assembly coupled to said enclosure and having three line bus subassemblies and three load bus subassemblies; and
wherein said six-pole circuit breaker quick disconnects engage said three-pole network protector bus assembly with two adjacent line quick disconnects of said six-pole circuit breaker coupled to each line bus sub-assembly and with two adjacent load quick disconnects of said six-pole circuit breaker coupled to each load bus sub-assembly.

11. The network protector of claim 10 wherein:
said three-pole network protector bus assembly includes a line bus assembly having three elongated bus subassemblies;
said line bus sub-assemblies each having a stab extending generally perpendicular to the longitudinal axis of said line bus sub-assemblies;
each said line bus sub-assembly stab having a width sufficient to accommodate at least two circuit breaker quick disconnect assemblies; and
said three-pole network protector bus assembly further includes a load bus assembly having three elongated bus sub-assemblies;
said load bus sub-assemblies each having a stab extending generally perpendicular to the longitudinal axis of said load bus subassemblies;
each said load bus sub-assembly stab having a width sufficient to accommodate at least two circuit breaker quick disconnect assemblies.

12. The network protector of claim 11 wherein:
each said line bus sub-assembly stab has a width between about 2 in. and 4 in.; and
each said load bus sub-assembly stab has a width between about 2 in. and 4 in.

13. The network protector of claim 12 wherein:
each said line bus sub-assembly stab has a width of about 3 in.; and
each said load bus sub-assembly stab has a width of about 3 in.

14. The network protector of claim 12 wherein each said line bus sub-assembly and load bus sub-assembly includes a plurality of bus conductive members maintained in a spaced relation.

15. The network protector of claim 12 wherein said line bus assembly includes two offset buses, each said offset bus coupled to, and in electrical communication with, a separate line bus sub-assembly and extending in a direction generally perpendicular to the longitudinal axis of said line bus sub-assemblies and the axis of said line bus sub-assembly stabs.

16. The network protector bus assembly of claim 11 wherein:
said line bus sub-assembly includes a phase A line bus sub-assembly, a phase B line bus sub-assembly, phase C line bus sub-assembly;
said load bus sub-assembly includes a phase A line bus sub-assembly, a phase B line bus sub-assembly, phase C line bus sub-assembly;
each said line phase A line bus sub-assembly stab, phase C line bus sub-assembly stab, phase A load bus sub-assembly stab, and phase C load bus sub-assembly stab having a width between about 7 in. and 9 in.; and
each said line phase B line bus sub-assembly stab and phase B load bus sub-assembly stab having a width between about 10 in. and 14 in.

17. The network protector of claim 16 wherein:
each said line phase A line bus sub-assembly stab phase C line bus sub-assembly stab, phase A load bus sub-assembly stab, and phase C load bus sub-assembly stab having a width of about 8.25 in.; and
each said line phase B line bus sub-assembly stab and phase B load bus sub-assembly stab having a width of about 12 in.

18. The network protector of claim 17 wherein each said line bus sub-assembly and load bus sub-assembly includes a plurality of bus conductive members maintained in a spaced relation.

19. The network protector of claim 16 wherein said line bus assembly includes two offset buses, one said offset bus coupled to, and in electrical communication with, either said phase A line bus subassembly or phase C line bus sub-assembly and extending in a direction generally perpendicular to the longitudinal axis of said line bus sub-assemblies and the axis of said line bus sub-assembly stabs.

20. The network protector of claim 10 wherein said six-pole circuit breaker is rated to carry a current of at least 4500 amperes.
